(19) United States
(12) Patent Application Publication
(10) Pub. No.: US 2009/0187375 A1
(43) Pub. Date: Jul. 23, 2009

(54) TOUCH SENSOR, METHOD AND PROGRAM FOR CONTROLLING TOUCH SENSOR

(75) Inventors: Masahiro Kinoshita, Kyoto-shi (JP); Hiroyuki Fujita, Otsu-shi (JP); Takeshi Horiuchi, Sanda-shi (JP); Masaya Chikaoka, Tokyo (JP); Yoshitsugu Suehiro, Kyoto-shi (JP)

Correspondence Address: OSHA LIANG L.L.P., TWO HOUSTON CENTER, 909 FANNIN, SUITE 3500, HOUSTON, TX, 77010, US

(73) Assignee: OMRON CORPORATION, Kyoto (JP)

(21) Appl. No.: 12/355,623

(22) Filed: Jan. 16, 2009

(30) Foreign Application Priority Data
Jan. 17, 2008 (JP) 2008-007629

(51) Int. Cl. G01B 7/008

(52) U.S. Cl. 702/158

(57) ABSTRACT

To detect a position an object is brought into contact or brought into proximity of the contact regions arranged with a capacitance sensor at high precision by successive values with a small number of capacitance sensors. An intensity acquiring unit acquires intensities of change in capacitance detected by capacitance sensors as detection results of when annularly arranged with respect to a first quadrant to a fourth quadrant. A horizontal calculation unit calculates a detection position in a horizontal direction of a position an object is brought into contact or brought into proximity. A vertical direction calculation unit calculates a detection position in a vertical direction of a position an object is brought into contact or brought into proximity. A position output unit outputs positions in the horizontal direction and the vertical direction of the position the object is brought into contact or brought into proximity.

### BACKGROUND OF THE INVENTION

1. Technical Field

The present invention relates to touch sensors, and methods and programs for controlling the touch sensor, and in particular, to a touch sensor capable of accurately detecting successive contact positions or proximate positions with a small number of sensors, and a method and a program for controlling the touch sensor.

2. Related Art

A slider type touch sensor is generally widely used. The slider type touch sensor includes continuously detecting a contacting or a proximate position, and scrolling an image up and down, and left and right, for example, in correspondence to the movement amount.

More specifically, for example, there is proposed a touch sensor in which electrode sections Dx+, Dx−, Dy+, and Dy− are arranged on virtual X, Y axes, stray capacitance generated at each electrode section is detected, and a difference in the stray capacitance of the electrode sections Dx+, Dx− is taken out as a voltage value in the x-axis direction corresponding thereto and a difference in the stray capacitance of the electrode sections Dy+, Dy− is taken out as a voltage value in the Y-axis direction corresponding thereto to detect the position, and scroll the image from the movement amount (refer to, for example, Japanese Unexamined Patent Publication No. 08-194578).

A touch sensor of determining the capacitance from each signal of a plurality of electrodes, and determining positional information of an input object is proposed. A secondary fitting procedure, a gravity center interpolation method, and the like are applied for the position algorithm to obtain the position from the polar coordinates (refer to, for example, Japanese Unexamined Patent Publication No. 2005-522797).

### SUMMARY

However, in the method described in Japanese Unexamined Patent Publication No. 08-194578, the x-coordinate is detected only from the capacitance of two electrodes arranged on the x-axis, and the y-coordinate is detected only from the capacitance of two electrodes arranged on the y-axis, and thus the sensitivity of the x-coordinate or the y-coordinate sometimes becomes extremely small depending on the position where the finger touches, and furthermore, it is difficult to enhance the detection accuracy since the detection is always made from the same electrodes.

In the method described in Japanese Unexamined Patent Publication No. 2005-522797, when a plurality of sensors is simultaneously subjected to the same influence due to change in temperature, simultaneous pushing, and the like, the touching is sometimes detected, and mistaken operation tends to easily occur. The polar coordinate and the angular speed can be obtained, but the distance (x-y coordinates) from the center of the touching finger cannot be recognized. That is, if another switch is arranged at the center or the periphery of the electrode, whether or not a position close to the switch is touched cannot be determined, and another algorithm needs to be added.

One or more embodiments of the present invention enables successive contact positions or proximate positions to be detected at high accuracy with a small number of sensors.

A touch sensor according to one aspect of the present invention includes a plurality of detection part including a sensor for detecting change in capacitance when an object is brought into contact or brought into proximity to at least four or more successively divided contact regions; an acquiring part for acquiring a first detection result of the detection part detecting a value at which the change in capacitance detected by the detection part is the largest, second and third detection results of the detection part adjacent to the detection part detecting the first detection result, and a fourth detection result of the detection part, which is not the detection part detecting the first detection result, adjacent to the detection part of either one out of the second and the third detection results, as detection results of a first quadrant to a fourth quadrant when annularly arranged with respect to the first quadrant to the fourth quadrant in correspondence to the arrangement of the detection part; a horizontal position calculation part for calculating a detection position in a horizontal direction of a position where the object is brought into contact or brought into proximity with a center position of the detection part arranged in the first quadrant to the fourth quadrant as a reference by subtracting a sum of the detection result of the second quadrant and the detection result of the third quadrant from a sum of the detection result of the first quadrant and the detection result of the fourth quadrant, a vertical position calculation part for calculating a detection position in a vertical direction of a position where the object is brought into contact or brought into proximity with a center position of the detection part arranged in the first quadrant to the fourth quadrant as a reference by subtracting a sum of the detection result of the third quadrant and the detection result of the fourth quadrant from a sum of the detection result of the first quadrant and the detection result of the second quadrant; and an output part for outputting the positions in the horizontal direction and the vertical direction of the position where the object is brought into contact or brought into proximity calculated by the horizontal calculation part and the vertical calculation part.

The acquiring part may acquire the first detection result of the detection part detecting a value at which the change in capacitance detected by the detection part is the largest, the second and third detection results of the detection part adjacent to the detection part detecting the first detection result, and the fourth detection result of the detection part, which is not the detection part detecting the first detection result, adjacent to the detection part of larger detection result of the second and the third detection results, as detection results of a first quadrant to a fourth quadrant when annularly arranged with respect to the first quadrant to the fourth quadrant in correspondence to the arrangement of the detection part.

An angle calculation part may be further arranged for calculating an angle with respect to the horizontal direction or the vertical direction of the position where the object is brought into contact or brought into proximity with the center position of the detection part arranged in the first quadrant to the fourth quadrant as a reference from the positions in the horizontal direction and the vertical direction of the position where the object is brought into contact or brought into proximity calculated by the horizontal calculation part and the vertical calculation part.

A distance calculation part may be further arranged for calculating a distance from the center position of the detection part arranged in the first quadrant to the fourth quadrant to the position where the object is brought into contact or brought into proximity from the positions in the horizontal direction and the vertical direction of the position where the object is brought into contact or brought into proximity calculated by the horizontal calculation part and the vertical calculation part.

A scroll part may be further arranged for scrolling an image in correspondence to change in positions in the horizontal direction and the vertical direction of the position where the object is brought into contact or brought into proximity outputted by the output part; wherein the scroll part changes scroll speed based on the distance and the angle.

Assumption is made that error has occurred if the distance from the center position of the detection part arranged in the first quadrant to the fourth quadrant to the position where the object is brought into contact or brought into proximity calculated by the distance calculation part is not a magnitude of a predetermined range; and the output part may stop the output of the positions in the horizontal direction and the vertical direction of the position where the object is brought into contact or brought into proximity.

The plurality of detection part may be linearly arranged.

If the detection part detecting the first detection result is arranged at an end of the linear arrangement or adjacent to the detection part at the end, the acquiring part may acquire the detection results of four detection part in succession from the end including the first detection result as the detection results of the first quadrant to the fourth quadrant when annularly arranged with respect to the first quadrant to the fourth quadrant in correspondence to the arrangement of the detection part.

The plurality of detection part may be annularly arranged.

A method for controlling a touch sensor according to one aspect of the present invention is a method for controlling a touch sensor including a plurality of detection part including a sensor for detecting change in capacitance when an object is brought into contact or brought into proximity to at least four or more successively divided contact regions; the method including an acquiring step of acquiring a first detection result of the detection part detecting a value at which the change in capacitance detected by the detection part is the largest, second and third detection results of the detection part adjacent to the detection part detecting the first detection result, and a fourth detection result of the detection part, which is not the detection part detecting the first detection result, adjacent to the detection part of either one out of the second and the third detection results, as detection results of a first quadrant to a fourth quadrant when annularly arranged with respect to the first quadrant to the fourth quadrant in correspondence to the arrangement of the detection part; a horizontal position calculation step of calculating a detection position in a horizontal direction of a position where the object is brought into contact or brought into proximity with a center position of the detection part arranged in the first quadrant to the fourth quadrant as a reference by subtracting a sum of the detection result of the second quadrant and the detection result of the third quadrant from a sum of the detection result of the first quadrant and the detection result of the fourth quadrant, a vertical position calculation step of calculating a detection position in a vertical direction of a position where the object is brought into contact or brought into proximity with a center position of the detection part arranged in the first quadrant to the fourth quadrant as a reference by subtracting a sum of the detection result of the third quadrant and the detection result of the fourth quadrant from a sum of the detection result of the first quadrant and the detection result of the second quadrant; and an output step of outputting the positions in the horizontal direction and the vertical direction of the position where the object is brought into contact or brought into proximity calculated by the process of the horizontal calculation step and the process of the vertical calculation step.

A program according to one aspect of the present invention is a program for causing a computer for controlling a touch sensor, which includes a plurality of detection part including a sensor for detecting change in capacitance when an object is brought into contact or brought into proximity to at least four or more successively divided contact regions, to execute the processes including an acquiring step of acquiring a first detection result of the detection part detecting a value at which the change in capacitance detected by the detection part is the largest, second and third detection results of the detection part adjacent to the detection part detecting the first detection result, and a fourth detection result of the detection part, which is not the detection part detecting the first detection result, adjacent to the detection part of either one out of the second and the third detection results, as detection results of a first quadrant to a fourth quadrant when annularly arranged with respect to the first quadrant to the fourth quadrant in correspondence to the arrangement of the detection part; a horizontal position calculation step of calculating a detection position in a horizontal direction of a position where the object is brought into contact or brought into proximity with a center position of the detection part arranged in the first quadrant to the fourth quadrant as a reference by subtracting a sum of the detection result of the second quadrant and the detection result of the third quadrant from a sum of the detection result of the first quadrant and the detection result of the fourth quadrant, a vertical position calculation step of calculating a detection position in a vertical direction of a position where the object is brought into contact or brought into proximity with a center position of the detection part arranged in the first quadrant to the fourth quadrant as a reference by subtracting a sum of the detection result of the third quadrant and the detection result of the fourth quadrant from a sum of the detection result of the first quadrant and the detection result of the second quadrant; and an output step of outputting the positions in the horizontal direction and the vertical direction of the position where the object is brought into contact or brought into proximity calculated by the process of the horizontal calculation step and the process of the vertical calculation step.

In the touch sensor, and the method and the program for controlling the touch sensor according to one aspect of the present invention, change in capacitance when an object is brought into contact or brought into proximity to at least four or more successively divided contact regions is detected by a plurality of sensors; a first detection result of the sensor detecting a value at which the change in capacitance detected by the sensors is the largest, second and third detection results of the sensors adjacent to the sensor detecting the first detection result, and a fourth detection result of the sensor, which is not the sensor detecting the first detection result, adjacent to the sensor of either one out of the second and the third detection results are acquired as detection results of a first quadrant to a fourth quadrant when annularly arranged with respect to the first quadrant to the fourth quadrant in correspondence to the arrangement of the sensors; a detection position in a horizontal direction of a position where the object is brought into contact or brought into proximity with a center position of the sensors arranged in the first quadrant to the fourth quadrant as a reference is calculated by subtracting a sum of the detection result of the second quadrant and the detection result of the third quadrant from a sum of the detection result of the first quadrant and the detection result of the fourth quadrant; a detection position in a vertical direction of a position where the object is brought into contact or brought into proximity with a center position of the sensors arranged in the first quadrant to the fourth quadrant as a reference is calculated by subtracting a sum of the detection result of the third quadrant and the detection result of the fourth quadrant from a sum of the detection result of the first quadrant and the detection result of the second quadrant; and calculated positions in the horizontal direction and the vertical direction of the position where the object is brought into contact or brought into proximity are outputted.

The plurality of detection part including a sensor for detecting change in capacitance when an object is brought into contact or brought into proximity to at least four or more successively divided contact regions in the touch sensor of one aspect of the present invention is, for example, capacitance sensor; an acquiring part for acquiring a first detection result of the detection part detecting a value at which the change in capacitance detected by the detection part is the largest, second and third detection results of the detection part adjacent to the detection part detecting the first detection result, and a fourth detection results of the detection part, which is not the detection part detecting the first detection result, adjacent to the detection part of either one out of the second and the third detection results, as detection results of a first quadrant to a fourth quadrant when annularly arranged with respect to the first quadrant to the fourth quadrant in correspondence to the arrangement of the detection part is, for example, an intensity acquiring unit; a horizontal position calculation part for calculating a detection position in a horizontal direction of a position where the object is brought into contact or brought into proximity with a center position of the detection part arranged in the first quadrant to the fourth quadrant as a reference by subtracting a sum of the detection result of the second quadrant and the detection result of the third quadrant from a sum of the detection result of the first quadrant and the detection result of the fourth quadrant is, for example, a horizontal calculation unit; a vertical position calculation part for calculating a detection position in a vertical direction of a position where the object is brought into contact or brought into proximity with a center position of the detection part arranged in the first quadrant to the fourth quadrant as a reference by subtracting a sum of the detection result of the third quadrant and the detection result of the fourth quadrant from a sum of the detection result of the first quadrant and the detection result of the second quadrant is, for example, a vertical calculation unit; and an output part for outputting the positions in the horizontal direction and the vertical direction of the position where the object is brought into contact or brought into proximity calculated by the horizontal calculation part and the vertical calculation part is, for example, the position output unit.

In other words, the detection intensity of each capacitance sensor arranged in four or more divided successive contact regions is acquired by the intensity acquiring unit; the detection results of the four successively arranged capacitance sensors including capacitance of each of the capacitance sensor of strongest intensity, the capacitance sensors adjacent to such a capacitance sensor, and the capacitance sensor, which is not the capacitance of strongest intensity, adjacent to one of the capacitance sensors of the capacitance sensors adjacent to the capacitance sensor of strongest intensity are handled as detection results A to D of the capacitance sensors arranged in the first quadrant to the fourth quadrant, in which case, when the center of a unit circle of the first quadrant to the fourth quadrant is the origin, the horizontal position x where the object is brought into contact or brought into proximity is obtained as ((A+D)−(B+C)) and the vertical position y is obtained as ((A+B)−(C+D)). Furthermore, the angle in the horizontal direction of the position where the object is brought into contact or brought into proximity with the center position of the four capacitance sensors as a reference is obtained as angle θ=arctan(x/y). The position where the object is brought into contact or brought into proximity is obtained in correspondence to the actual arrangement of the four capacitance sensors arranged in the first quadrant to the fourth quadrant based on the angle.

As a result, the position where the object is brought into contact or brought into proximity of the successive contact regions arranged with the capacitance sensor can be detected at high accuracy by successive values with a small number of capacitance sensors.

According to one or more embodiments of the present invention, out of the successive contact regions arranged with the capacitance sensor, the successive contact positions or proximate positions where the object is brought into contact or brought into proximity can be detected at high accuracy with a small number of capacitance sensors.

### BRIEF DESCRIPTION OF THE DRAWINGS

FIG. 1 shows a view showing a configuration example of an embodiment of a touch sensor applied with the present invention;

FIG. 2 shows a flowchart for describing a scrolling process by the touch sensor of FIG. 1;

FIG. 3 shows a view describing the scrolling process by the touch sensor of FIG. 1;

FIG. 4 shows a view showing a configuration example of another embodiment of the touch sensor;

FIG. 5 shows a flowchart for describing a scrolling process by the touch sensor of FIG. 4;

FIG. 6 shows a view describing the scrolling process by the touch sensor of FIG. 4;

FIG. 7 shows a view showing a configuration example of still another embodiment of a touch sensor;

FIG. 8 shows a flowchart for describing a scrolling process by the touch sensor of FIG. 7;

FIG. 9 shows a view describing the scrolling process by the touch sensor of FIG. 7; and

FIG. 10 shows a view describing a personal computer.

### DETAILED DESCRIPTION

Embodiments of the present invention will be described below, where the correspondence relationship between configuration requirements of the present invention and the embodiments described in the detailed description of the invention is as follows. This description is provided to confirm that the embodiments supporting the present invention are described in the detailed description of the invention. Therefore, even if there is an embodiment described in the detailed description of the invention but not described herein as an embodiment corresponding to the configuration requirement of the present invention, this does not mean that such an embodiment does not correspond to the configuration requirement. By contrary, even if the embodiment is described herein as corresponding to the configuration requirement, this does not mean that such an embodiment does not correspond to the configuration requirement other than the relevant configuration requirement.

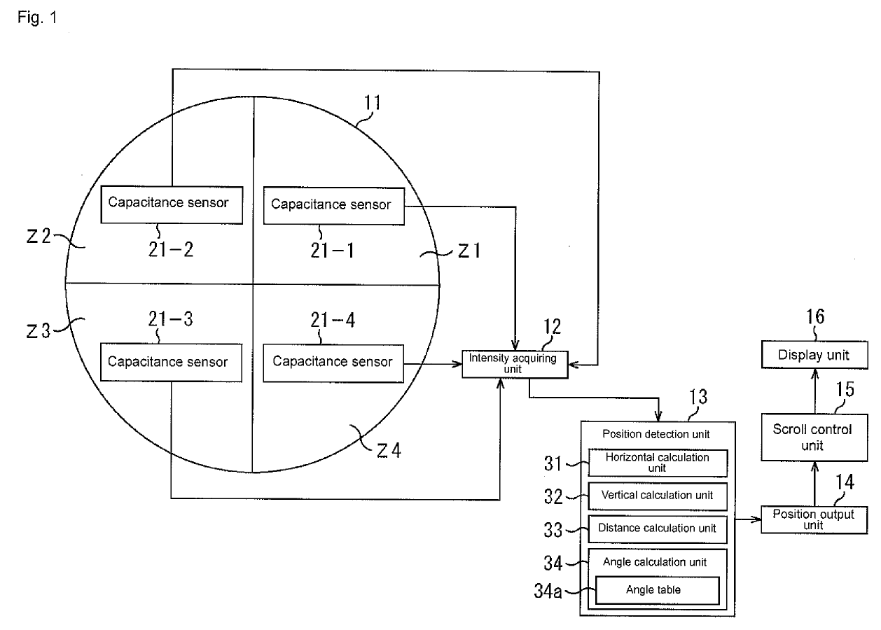

In other words, the touch sensor according to one aspect of the present invention includes a plurality of detection part (e.g., capacitance sensors 21-1 to 21-4 of FIG. 1) including a sensor for detecting change in capacitance by contact or proximity of an object with respect to each successive contacting region divided into at least four or more portions; an acquiring part (e.g., intensity acquiring unit 12 of FIG. 1) for acquiring a first detection result of the detection part detecting a value at which the change in the capacitance detected by the detection part is the largest, second and third detection results of the detection part adjacent to the detection part detecting the first detection result, and a fourth detection result of a detection part, which is not the detection part detecting the first detection result, adjacent to the detection part of either one out of the second and the third detection results as detection results of a first quadrant to a fourth quadrant when annularly arranged with respect to the first quadrant to the fourth quadrant in correspondence to the arrangement of the detection part; a horizontal position calculation part (e.g., horizontal calculation unit 31 of FIG. 1) for calculating a detected position in a horizontal direction of the position where the object is brought into contact or brought into proximity with a center position of the detection part arranged in the first quadrant to the fourth quadrant as a reference by subtracting the sum of the detection result of the second quadrant and the detection result of the third quadrant from the sum of the detection result of the first quadrant and the detection result of the fourth quadrant; a vertical position calculation part (e.g., vertical calculation unit 32 of FIG. 1) for calculating a detected position in a vertical direction of the position where the object is brought into contact or brought into proximity with a center position of the detection part arranged in the first quadrant to the fourth quadrant as a reference by subtracting the sum of the detection result of the third quadrant and the detection result of the fourth quadrant from the sum of the detection result of the first quadrant and the detection result of the second quadrant; and an output part (e.g., position output unit 14 of FIG. 1) for outputting the positions in the horizontal direction and the vertical direction of the position where the object is brought into contact or brought into proximity calculated by the horizontal calculation part and the vertical calculation part.

The acquiring part (e.g., intensity acquiring unit 12 of FIG. 1) can acquire the first detection result of the detection part detecting a value at which the change in the capacitance detected by the detection part is the largest, second and third detection results of the detection part adjacent to the detection part detecting the first detection result, and a fourth detection result of a detection part, which is not the detection part detecting the first detection result, adjacent to the detection part of larger detection result of the second and the third detection results as detection results of the first quadrant to the fourth quadrant when annularly arranged with respect to the first quadrant to the fourth quadrant in correspondence to the arrangement of the detection part.

An angle calculation part (e.g., angle calculation unit 34 of FIG. 1) may be further arranged for calculating an angle with respect to the horizontal direction or the vertical direction of the position where the object is brought into contact or brought into proximity with the center position of the detection part arranged in the first quadrant to the fourth quadrant as a reference from the positions in the horizontal direction and the vertical direction of the position where the object is brought into contact or brought into proximity calculated by the horizontal calculation part and the vertical calculation part.

A distance calculation part (e.g., distance calculation unit 33 of FIG. 1) may be further arranged for calculating a distance from a center position of the detection part arranged in the first quadrant to the fourth quadrant to the position where the object is brought into contact or brought into proximity from the positions in the horizontal direction and the vertical direction of the position where the object is brought into contact or brought into proximity calculated by the horizontal calculation part and the vertical calculation part.

A scroll part (e.g., scroll control unit 15 of FIG. 1) may be further arranged for scrolling an image in correspondence to change in positions in the horizontal direction and the vertical direction of the position where the object is brought into contact or brought into proximity outputted by the output part, which scroll part can change the scrolling speed based on the distance and the angle.

If the distance from a center position of the detection part arranged in the first quadrant to the fourth quadrant to the position where the object is brought into contact or brought into proximity calculated by the distance calculation part is not a magnitude of a predetermined range, assumption is made that error has occurred, and the output part (e.g., position output unit 14 of FIG. 1) stops the output of the positions in the horizontal direction and the vertical direction of the position where the object is brought into contact or brought into proximity.

If the detection part detecting the first detection result is arranged at the linearly arranged end or adjacent to the detection part at the end, the acquiring part (e.g., intensity acquiring unit 12 of FIG. 1) acquires the detection results of four successive detection part from the end including the first detection result as the detection results of the first quadrant to the fourth quadrant when annularly arranged with respect to the first quadrant to the fourth quadrant in correspondence to the arrangement of the detection part.

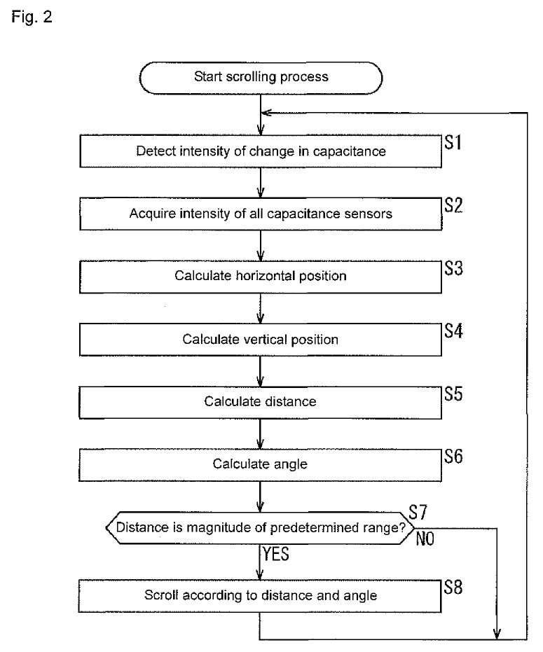

A method or a program for controlling the touch sensor according to one aspect of the present invention is a method for controlling a touch sensor including a plurality of detection part including a sensor for detecting change in capacitance by contact or proximity of an object with respect to each successive contacting region divided into at least four or more portions; the method including an acquiring step (e.g., step S2 of FIG. 2) of acquiring a first detection result of the detection part detecting a value at which the change in the capacitance detected by the detection part is the largest, second and third detection results of the detection part adjacent to the detection part detecting the first detection result, and a fourth detection result of a detection part, which is not the detection part detecting the first detection result, adjacent to the detection part of larger detection result of the second and the third detection results as detection results of a first quadrant to a fourth quadrant when annularly arranged with respect to the first quadrant to the fourth quadrant in correspondence to the arrangement of the detection part; a horizontal position calculation step (e.g., step S3 of FIG. 2) of calculating a detected position in a horizontal direction of the position where the object is brought into contact or brought into proximity with a center position of the detection part arranged in the first quadrant to the fourth quadrant as a reference by subtracting the sum of the detection result of the second quadrant and the detection result of the third quadrant from the sum of the detection result of the first quadrant and the detection result of the fourth quadrant; a vertical position calculation step (e.g., step S4 of FIG. 2) of calculating a detected position in a vertical direction of the position where the object is brought into contact or brought into proximity with a center position of the detection part arranged in the first quadrant to the fourth quadrant as a reference by subtracting the sum of the detection result of the third quadrant and the detection result of the fourth quadrant from the sum of the detection result of the first quadrant and the detection result of the second quadrant; and an output step (e.g., step S8 of FIG. 2) of outputting the positions in the horizontal direction and the vertical direction of the position where the object is brought into contact or brought into proximity calculated by the process of the horizontal calculation step and the process of the vertical calculation step.

FIG. 1 shows a view showing a configuration example of an embodiment of a touch sensor according to the present invention.

The touch sensor of FIG. 1 allows an image displayed on a display unit 16 to be scrolled vertically or horizontally according to the movement distance and the speed by tracing a contact section 11, which is a substantially circular flat plate, in a clockwise direction or a counterclockwise direction with a finger.

The contact section 11 has the capacitance sensors 21-1 to 21-4 embedded on a back side of the surface to be traced by the finger of the user concentrically with respect to the center of the contact section 11 and at equal angle. The contact section 11 is sectionalized into regions Z1 to Z4 for every 90°, each of which regions is set so as to correspond to the first quadrant to the fourth quadrant when the contact section 11 is assumed as a unit circle. The capacitance sensors 21-1 to 21-4 are arranged in the vicinity of a middle of an angle of the middle of the respective regions Z1 to Z4 and the distance from the center. The capacitance sensors 21-1 to 21-4 each detects the intensity of change in capacitance that occurs when an object is brought into contact or brought into proximity, and provides the detected intensity of the change in capacitance to the intensity acquiring unit 12 as a detection result. The capacitance sensors 21-1 to 21-4 are simply referred to as a capacitance sensor 21 when sectionalization is unnecessary, and other configurations are similarly referred to.

The intensity acquiring unit 12 acquires detection results A to D indicating the intensity of the change in the capacitance provided from each of capacitance sensors 21-1 to 21-4, and provides the same to a position detection unit 13.

The position detection unit 13 is configured by a horizontal calculation unit 31, a vertical calculation unit 32, a distance calculation unit 33, and an angle calculation unit 34, and calculates a position (horizontal position x, vertical position y, distance r, and angle θ) at where the finger is brought into contact or brought into proximity on the contact section 11 based on the detection results A to D of the capacitance sensors 21-1 to 21-4 provided by the intensity acquiring unit 12, and provides the information on the position of the finger on the contact section 11, which is the calculation result, to a position output unit 14.

The horizontal calculation unit 31 executes a calculation expressed in equation (1) below based on the detection results A to D of the capacitance sensors 21-1 to 21-4 provided by the intensity acquiring unit 12 to calculate the horizontal position x with a center position of the contact section 11 (center position arranged with the capacitance sensors 21-1 to 21-4) as a reference, and a rightward direction in the figure as x direction and an upward direction in the figure as y direction of the information on the position of the finger on the contact section 11.

x=k((A+D)−(B+C)) (1)

In equation (1), x represents the horizontal position x on the contact section 11, k represents a correction coefficient k, and A to D each represents the detection result indicating the intensity of change in the capacitance of the capacitance sensors 21-1 to 21-4.

The vertical calculation unit 32 executes a calculation expressed in equation (2) below based on the detection results A to D of the capacitance sensors 21-1 to 21-4 provided by the intensity acquiring unit 12 to calculate the vertical position y with a center position of the contact section 11 as a reference, and a rightward direction in the figure as x direction and an upward direction in the figure as y direction of the information on the position of the finger on the contact section 11.

y=k((A+B)−(C+D)) (2)

In equation (2), y represents the vertical position y on the contact section 11, k represents a correction coefficient k, and A to D each represents the detection result indicating the intensity of change in the capacitance of the capacitance sensors 21-1 to 21-4.

The positions x and y are based on the bias of the intensity of change in the capacitance as described above, and qualitatively indicate the position of a finger H1 on the contact section 11 and thus have values that are not of an accurate position if the correction coefficient k is not included in equation (1) and equation (2). In order to accurately obtain the actual position, the correction coefficient k is set since the difference in bias of the intensity of change in the capacitance indicating the positions x and y and the actual position needs to be corrected in advance.

The distance calculation unit 33 calculates equation (3) below based on the horizontal position x of the position of the finger on the contact section 11, which is a calculation result of the horizontal calculation unit 31, and a vertical position y of the position of the finger on the contact section 11, which is a calculation result of the vertical calculation unit 32 to obtain a distance r from the center position of the contact section 11 to the position of the finger on the contact section 11.

r=√(x²+y²) (3)

The angle calculation unit 34 calculates equation (4) below based on the horizontal position x of the position of the finger on the contact section 11, which is a calculation result of the horizontal calculation unit 31, and a vertical position y of the position of the finger on the contact section 11, which is a calculation result of the vertical calculation unit 32 to obtain an angle θ to the position of the finger on the contact section 11 having an x-axis passing through the center of the contact section 11 as 0°.

θ=arctan(y/x) (4)

Here, arctan means arc tangent. The angle calculation unit 34 includes an angle table 34a storing values of θ corresponding to (y/x) in a form of a table, where the angle θ is read out from the angle table 34a based on the value of (y/x). This angle θ does not necessarily need to be an angle with respect to an axis in the x direction, and may be an angle with respect to an axis in the y direction.

The position output unit 14 provides the horizontal position x, the vertical position y, the distance r, and the angle θ provided from the position detection unit 13 to the scroll control unit 15. In this case, determination is made on whether or not the contact position or the proximate position of the finger is on the contact section 11 based on whether or not the distance r is a magnitude of a predetermined range, where if the distance r is not the magnitude of the predetermined range and the contact position or the proximate position of the finger is not on the contact section 11, assumption is made that error has occurred, and the provision of the horizontal position x, the vertical position y, the distance r, and the angle θ provided from the position detection unit 13 to the scroll control unit 15 is stopped.

The scroll control unit 15 scrolls, in a horizontal direction and a vertical direction, an image displayed on the display unit 16 configured by an LCD (Liquid Crystal Display) and the like based on the horizontal position x, the vertical position y, the distance r, and the angle θ provided from the position output unit 14 every second.

A scrolling process by the touch sensor of FIG. 1 will now be described with reference to a flowchart of FIG. 2.

In step S1, the capacitance sensors 21-1 to 21-4 of the contact section 11 respectively measure intensity A to D of change in the capacitance, and provides the intensity of change in the capacitance, which is the measurement result, to the intensity acquiring unit 12.

In step S2, the intensity acquiring unit 12 provides the acquired intensities A to D, which are measurement results, to the position detection unit 13.

In step S3, the horizontal calculation unit 31 obtains the horizontal position x by calculating equation (1).

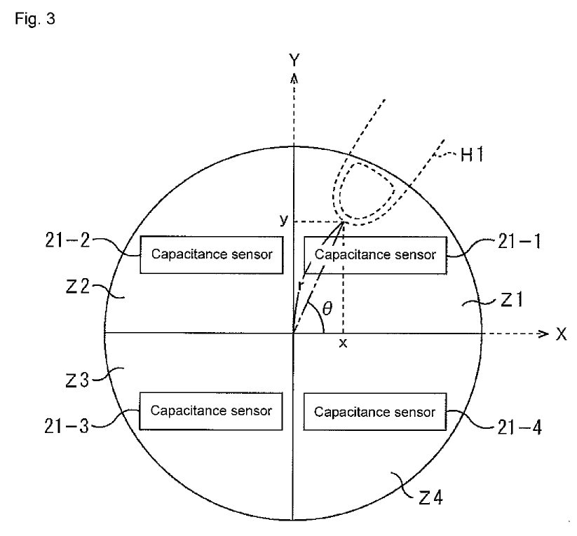

In other words, as shown in FIG. 3, the horizontal calculation unit 31 calculates equation (1) of subtracting the sum of the detection results of the second quadrant and the third quadrant from the sum of the detection results of the first quadrant and the fourth quadrant to obtain, as the horizontal position x of the position of the finger H1 on the control section 11, bias (difference in change of left and right capacitances of the contact section 11 in the figure) in the intensity of change in the capacitance in the horizontal direction by a finger H1 that is brought into contact or brought into proximity with the contact section 11.

In step S4, the vertical calculation unit 32 obtains the vertical position y by calculating equation (2).

In other words, as shown in FIG. 3, the vertical calculation unit 32 calculates equation (2) of subtracting the sum of the detection results of the third quadrant and the fourth quadrant from the sum of the detection results of the first quadrant and the second quadrant to obtain, as the vertical position y of the position of the finger H1 on the control section 11, bias (difference in change of upper and lower capacitances of the contact section 11 in the figure) in the intensity of change in the capacitance in the vertical direction by a finger H1 that is brought into contact or brought into proximity with the contact section 11.

In step S5, the distance calculation unit 33 obtains the distance r by calculating equation (3).

In other words, as shown in FIG. 3, the distance calculation unit 33 calculates equation (3) to obtain the distance r from the center of the position of the finger H1 on the contact section 11 based on a triangle theorem from the horizontal position x and the vertical position y of the position of the finger H1 brought into contact or brought into proximity with the contact section 11.

In step S6, the angle calculation unit 34 obtains the angle θ by calculating equation (4).

In other words, as shown in FIG. 3, the angle calculation unit 34 calculates equation (4) to obtain the angle θ corresponding to the value of (y/x) with reference to the angle table 34a from the horizontal position x and the vertical position y of the position of the finger H1 brought into contact or brought into proximity with the contact section 11.

The angle calculation unit 34 does not necessarily need to include the angle table 34a as long as the angle θ corresponding to the value of (y/x) can be calculated, and may obtain the angle θ through calculation. However, since the load on the calculation is large in the calculation of the angle θ based on the value of (y/x), the cost of calculation can be reduced and the processing speed can be enhanced if the angle table 34a is arranged and read out.

In step S7, the position detection unit 13 outputs, to the position output unit 14, the position x calculated by the horizontal calculation unit 31, the position y calculated by the vertical calculation unit 32, the distance r calculated by the distance calculation unit 33, and the angle θ calculated by the angle calculation unit 34. The position output unit 14 determines whether or not the distance r is the magnitude of the predetermined range based on the positions x, y, the distance r, and the angle θ provided from the position detection unit 13.

In other words, since a radius R of the contact section 11 is set in advance, the finger H1 does not exist on the contact section 11 when the distance r is larger than the radius R of the contact section 11. When the distance r is too small, the finger H1 exists near the middle of the contact section 11, and thus the contact section 11 may not be traced so as to rotate. The position output unit 14 determines whether or not the distance r is the magnitude of the predetermined range, that is, whether or not the finger H1 is at a position outside the contact section 11 or exists near the middle.

If determined that the distance r is the magnitude of the predetermined range, that is, the finger H1 is on the contact section 11 and traced so as to rotate in step S7, the position output unit 14 provides the distance r and the angle θ to the scroll control unit 15 in step S8. The scroll control unit 15 obtains a difference between an angle θp immediately before and a provided current angle θc, and scrolls the display content of the display unit 16 according to the magnitude of the distance r, and the process returns to step S1.

In other words, since the difference (θc−θp) between the angle θp immediately before and the provided current angle θc is the movement angle Δθ of the finger H1 on the contact section 11, the scroll control unit 15 scrolls the image by the number of pixels of the scrolling amount corresponding to the movement angle Δθ. When the finger H1 is moved by the same movement angle Δθ on the contact section 11, the movement distance ΔL on the contact section 11 of the finger H1 becomes larger the larger the distance r, and smaller the smaller the distance r. Therefore, even if the movement angle Δθ is the same within a predetermined time, the finger H1 rapidly moves on the contact section 11 since the movement distance ΔL is larger the larger the distance r, and the finger H1 slowly moves on the contact section 11 since the movement distance ΔL is smaller the smaller the distance r. Therefore, the scroll control unit 15 executes scrolling by setting the scroll speed to high speed the larger the distance r, and the scroll speed to low speed the smaller the distance r.

If determined that the distance r is not the magnitude of the predetermined range, that is, the finger H1 is not on the contact section 11 or exist near the middle and not traced so as to rotate in step S7, the process of step S8 is skipped, and the process returns to step S1. That is, in this case, the position of the finger H1 cannot be accurately obtained on the contact section 11, and is handled as an error, and the information on the position of the finger H1 obtained for this time is not reflected on the scrolling.

Through the above processes, even with the touch sensor including four capacitance sensors, the movement angle indicating the contact position or the proximate position on the contact section 11 and the distance from the center can be accurately obtained with successive values by being concentrically arranged at equal interval. Consequently, the scrolling amount and the scrolling speed of a screen can be simultaneously and accurately controlled based on the movement angle and the distance from the center of the finger H1 that are accurately obtained.

An example of scrolling a display screen of the display unit 16 in correspondence to the movement of the finger on the contact section 11 from the four capacitance sensors with respect to a disc-shaped contact section 11 has been described, but the capacitance sensors can execute similar processes even if in greater number.

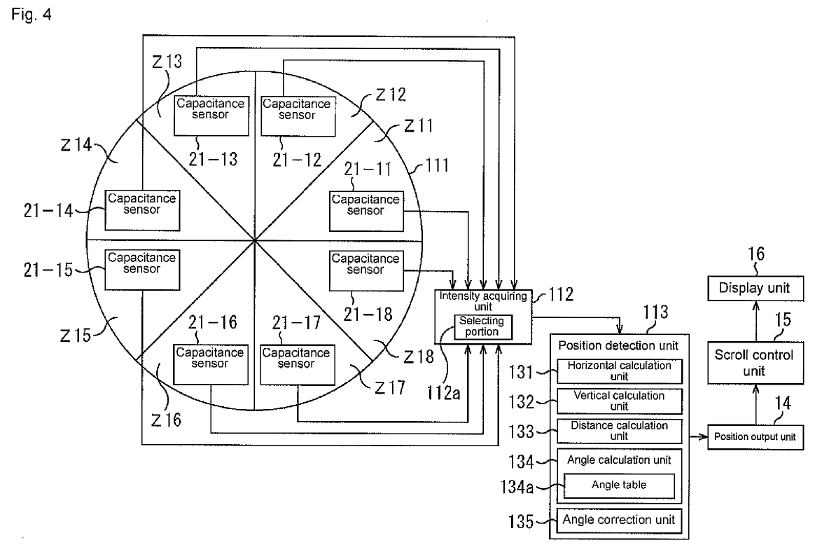

An example of scrolling the display screen of the display unit 16 in correspondence to the movement of the finger on a contact section 111 from eight capacitance sensors concentrically arranged at equal interval will be described with reference to FIG. 4. In the touch sensor of FIG. 4, configurations having the same functions as the touch sensor of FIG. 1 are denoted with the same reference numerals, and the description thereof will be appropriately omitted.

In the touch sensor of FIG. 4, the basic configuration of the contact section 111 is such that capacitance sensors 21-11 to 21-18 are arranged in place of the capacitance sensors 21-1 to 21-4 in the contact section 11, where the capacitance sensor 21-11 is arranged in a region Z11 of a first quadrant, the capacitance sensor 21-12 is arranged in a region Z12 of the first quadrant, the capacitance sensor 21-13 is arranged in a region Z13 of a second quadrant, the capacitance sensor 21-14 is arranged in a region Z14 of the second quadrant, the capacitance sensor 21-15 is arranged in a region Z15 of a third quadrant, the capacitance sensor 21-16 is arranged in a region Z16 of the third quadrant, the capacitance sensor 21-17 is arranged in a region Z17 of a fourth quadrant, and the capacitance sensor 21-18 is arranged in a region Z18 of the fourth quadrant. The capacitance sensors 21-11 to 21-18 and the capacitance sensors 21-1 to 21-4 are all similar.

The capacitance sensors 21-11 to 21-18 each detects the intensity of change in capacitance that occurs when an object is brought into contact or brought into proximity, and provides the detected intensity of the change in capacitance to an intensity acquiring unit 112 as a detection result.

The intensity acquiring unit 112 controls a selecting portion 112a, and causes the selecting portion 112a to select the intensity of four capacitance sensors 21 arranged in succession including, of the eight detection results indicating the intensity of the change in capacitance provided by each of capacitance sensors 21-11 to 21-18, intensity of the capacitance sensor 21_max detecting the strongest intensity, intensity of two capacitance sensors 21_ne adjacent to the capacitance sensor 21_max, and intensity of the capacitance sensor 21_subne, which is not the capacitance sensor 21_max, adjacent to the capacitance sensor 21_ne of larger intensity of the two capacitance sensors 21_ne, and provide them to a position detection unit 113 as detection results A to D.

The position detection unit 113 includes a horizontal calculation unit 131, a vertical calculation unit 132, a distance calculation unit 133, an angle calculation unit 134, and an angle correction unit 135. The horizontal calculation unit 131, the vertical calculation unit 132, the distance calculation unit 133, and the angle calculation unit 134 are of configurations having the same functions as the horizontal calculation unit 31, the vertical calculation unit 32, the distance calculation unit 33, and the angle calculation unit 34. The angle correction unit 135 corrects the angle θ calculated by the angle correction unit 134 according to the installed number of capacitance sensor 21, and obtains an angle θ′.

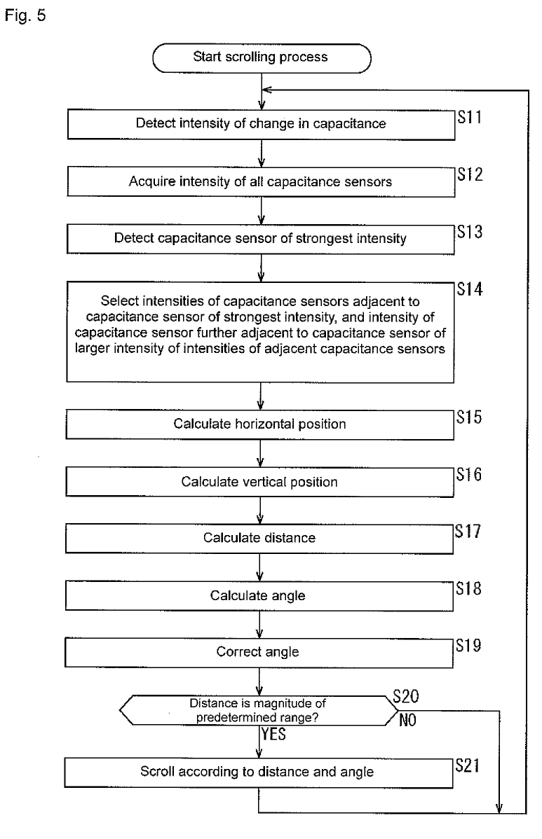

A scrolling process by the touch sensor of FIG. 4 will now be described with reference to the flowchart of FIG. 5.

In step S11, the capacitance sensors 21-11 to 21-18 of the contact section 111 respectively measure intensity of change in capacitance, and provide the intensity of change in capacitance, which is the measurement result, to the intensity acquiring unit 112.

In step S12, the intensity acquiring unit 112 acquires the respective intensity of change in capacitance provided from the capacitance sensors 21-11 to 21-18.

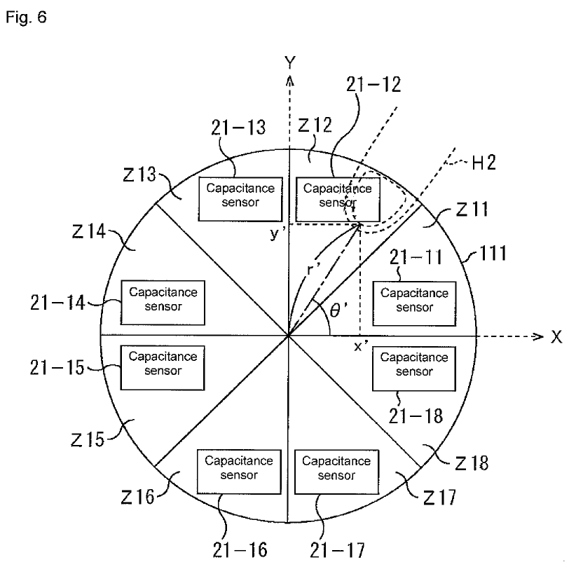

In step S13, the intensity acquiring unit 112 controls the selecting portion 112a to detect the detection result of the strongest intensity from the acquired intensities of change in capacitance of the capacitance sensors 21-11 to 21-18. In other words, for example, if the finger H2 exists on the region Z12 of the contact section 111, as shown in FIG. 6, the intensity of change in capacitance detected in the capacitance sensor 21-12 is detected as the strongest intensity. Thus, in the case shown in FIG. 6, the selecting portion 112a detects the detection result of the capacitance sensor 21-12 (capacitance sensor 21_max) in which the intensity of change in capacitance is detected as the strongest intensity.

In step S14, the selecting portion 112a selects the intensities of the two capacitance sensors 21_ne adjacent to the capacitance sensor 21_max of strongest intensity, and the intensity of the capacitance sensor 21_subne, which is not the capacitance sensor 21_max, adjacent to the capacitance sensor 21_ne detecting the larger intensity of the capacitance sensors 21_ne, and provides, with the intensity of the capacitance sensor 21_max, to the position detection unit 113 as detection results A to D corresponding to the first quadrant to the fourth quadrant in counterclockwise in the order of four successive regions.

In other words, in the case of FIG. 6, the intensity, which is the detection result of the capacitance sensor 21-12, is the strongest, and thus the selecting portion 112a selects the intensity of the capacitance sensor 21-12 as the intensity of the capacitance sensor 21_max. The selecting portion 112a also selects the intensities of the capacitance sensors 21-11, 21-13 adjacent to the capacitance sensor 21-12 respectively as the intensity of capacitance sensor 21_ne. Furthermore, if the intensity of the capacitance sensor 21-13 is stronger of the detection results of the capacitance sensors 21-11, 21-13, for example, the selecting portion 112a selects the intensity of the capacitance sensor 21-14, which is not the capacitance sensor 21-12 (capacitance sensor 21_max), adjacent to the capacitance sensor 21-13 as the intensity of the capacitance sensor 21_subne.

As a result, the selecting portion 112a selects the detection results detected in each of capacitance sensors 21-11 to 21-14 as detection results A to D, and provides the same to the position detection unit 113.

That is, the detection results of the capacitance sensors 21-11 to 21-14 of the regions Z11 to Z14 successively arranged in the first quadrant and the second quadrant shown in FIG. 6 are handled similar to the detection results of the capacitance sensors 21-1 to 21-4 of the regions Z1 to Z4 in the first quadrant to the fourth quadrant in FIG. 3, and are provided to the position detection unit 113.

In step S15, the horizontal calculation unit 131 obtains the horizontal position x by calculating equation (1).

In other words, the horizontal calculation unit 131 handles the sum of the detection results of the capacitance sensors 21-11, 21-14 of FIG. 6 as if the sum of the detection results of the first quadrant and the fourth quadrant in FIG. 3, and handles the sum of the detection results of the capacitance sensors 21-12, 21-13 of FIG. 6 as if the sum of the detection results of the second quadrant and the third quadrant in FIG. 3, and calculates equation (1) of subtracting the respective sum to obtain, as the horizontal position x, the bias in intensity of change in the capacitance in the horizontal direction by the finger H2 brought into contact or brought into proximity with the contact section 111 (difference in change in left and right capacitances of the contact section 111 in the figure) as being the bias in intensity of change in the capacitance in the horizontal direction by the finger H1 brought into contact or brought into proximity with the contact section 11 (difference in change in left and right capacitances of the contact section 11 in the figure).

The finger H1 in FIG. 3 is handled as existing on the region Z2 when corresponding to the finger H2 shown in FIG. 6. As hereinafter described, the horizontal position x is the horizontal position corresponding to FIG. 3, and differs from the horizontal position x′ shown in FIG. 6.

In step S16, the vertical calculation unit 132 obtains the vertical position y by calculating equation (2).

In other words, the vertical calculation unit 132 handles the sum of the detection results of the capacitance sensors 21-11, 21-11 of FIG. 6 as if the sum of the detection results of the first quadrant and the second quadrant in FIG. 3, and handles the sum of the detection results of the capacitance sensors 21-13, 21-14 of FIG. 6 as if the sum of the detection results of the third quadrant and the fourth quadrant in FIG. 3, and calculates equation (2) of subtracting the respective sum to obtain, as the vertical position y, the bias in intensity of change in the capacitance in the vertical direction by the finger H2 brought into contact or brought into proximity with the contact section 111 (difference in change in up and down capacitances of the contact section 111 in the figure) as being the bias in intensity of change in the capacitance in the horizontal direction by the finger H1 brought into contact or brought into proximity with the contact section 11 (difference in change in up and down capacitances of the contact section 11 in the figure).

As hereinafter described, the vertical position y is the vertical position corresponding to FIG. 3, and differs from the vertical position y′ shown in FIG. 6.

In step S17, the distance calculation unit 133 obtains the distance r by calculating the equation (3).

In other words, the distance calculation unit 133 calculates equation (3) to obtain the distance r from the center of the position of the finger H1 on the contact section 11 based on a triangle theorem from the horizontal position x and the vertical position y of FIG. 3 corresponding to the position of the finger H2 brought into contact or brought into proximity with the contact section 111 of FIG. 6.

As hereinafter described, the distance r corresponds to FIG. 3 and differs from the distance r′ shown in FIG. 6.

In step S18, the angle calculation unit 134 obtains the angle θ by calculating equation (4).

In other words, the angle calculation unit 134 calculates equation (4) to obtain the angle θ corresponding to the value of (y/x) with reference to the angle table 134a from the horizontal position x and the vertical position y of the position of the finger H1 of FIG. 3 corresponding to the finger H2 brought into contact or brought into proximity with the contact section 111 of FIG. 6.

As hereinafter described, the angle θ corresponds to FIG. 3, and differs from the angle θ′ shown in FIG. 6.

In step S19, the angle correction unit 135 corrects the angle θ in FIG. 3 to the angle θ′ in FIG. 6. In other words, since the detection results of the capacitance sensors 21-11 to 21-14 are handled as if the detection results of the first quadrant to the fourth quadrant in FIG. 3, the range of the angle θ obtained in the process of step S18 is 0°≦θ<360°. However, in FIG. 6, the capacitance sensors 21-11 to 21-14 are arranged in the first quadrant and the second quadrant, and thus the range of the angle θ′ shown in FIG. 6 is 0°≦θ′≦180°. That is, the angle θ can be assumed as a value representing the angle θ′ having a range of 0°≦θ′≦180° in the range of 0°≦θ<360°. The angle correction unit 135 corrects the angle θ to the angle θ′ through the calculation expressed in equation (5).

θ′=(φ/360)×θ (5)

In equation (5), φ shows the angle at where a region in which four successively arranged capacitance sensors 21 detecting the intensity selected by the selecting portion 112a measure the intensity of change in capacitance exists. The angle at where a region in which four successively arranged capacitance sensors 21 detecting the selected intensity measure the intensity of change in capacitance exists is determined by the number of capacitance sensor 21, and thus the angle θ′ is substantially corrected according to the installed number of capacitance sensors 21.

For instance, in the case of FIG. 6, a region in which the four successively arranged capacitance sensors 21 detecting the selected intensity measure the intensity of change in capacitance is regions Z11 to Z14, and thus φ is 180°. Therefore, the angle correction unit 135 multiplies ½ to the angle θ to correct the angle θ shown in FIG. 3 to the angle θ shown in FIG. 6.

In step S20, the position detection unit 113 outputs, to the position output unit 114, the position x calculated by the horizontal calculation unit 131, the position y calculated by the vertical calculation unit 132, the distance r calculated by the distance calculation unit 133, and the angle θ calculated by the angle calculation unit 134. The position output unit 14 determines whether or not the distance r is the magnitude of the predetermined range based on the positions x, y, the distance r, and the angle θ′ provided from the position detection unit 113.

In other words, since the detection results of the capacitance sensors 21-11 to 21-14 are handled as if the detection results of the first quadrant to the fourth quadrant in FIG. 3, a predetermined value Rv corresponding to a radius R′ of the contact section 111 is set for the distance r obtained in the process of step S17, where assumption is made that the finger H2 does not exist on the contact section 111 when the distance r is larger than the predetermined value Rv. When the distance r is too small, the finger H2 exists near the middle of the contact section 111, and thus assumption is made that the contact section 111 may not be traced so as to rotate. The position output unit 14 determines whether or not the distance r is the magnitude of the predetermined range, that is, whether or not the finger H2 is at a position outside the contact section 111 or exists near the middle.

If determined that the distance r is the magnitude of the predetermined range, that is, the finger H2 is on the contact section 111 and traced so as to rotate in step S20, the position output unit 14 provides the distance r and the angle θ′ to the scroll control unit 15 in step S21. The scroll control unit 15 obtains a difference between an angle θ′p immediately before and a provided current angle θ′c, and scrolls the display content of the display unit 16 according to the magnitude of the distance r, and the process returns to step S11.

Through the above processes, even with the touch sensor including four or more capacitance sensors, processing similar to the touch sensor including four capacitance sensors can be performed by using the detection results of the four successively arranged capacitance sensors including the capacitance sensor indicating the detection result of strongest intensity at a position other than the end, and the movement angle indicating the contact position or the proximate position on the contact section 111 and the distance from the center can be accurately obtained with successive values. Consequently, the scrolling amount and the scrolling speed of a screen can be simultaneously and accurately controlled based on the movement angle and the distance from the center of the finger H2 that are accurately obtained.

An example of arranging the capacitance sensors concentrically and at equal interval in an annular form has been described above, but the position brought into contact or brought into proximity can be successively and accurately detected by linearly arranging the capacitance sensors at equal interval by performing processing similar to the touch sensor including four or more capacitance sensors arranged in an annular form concentrically and at equal interval.

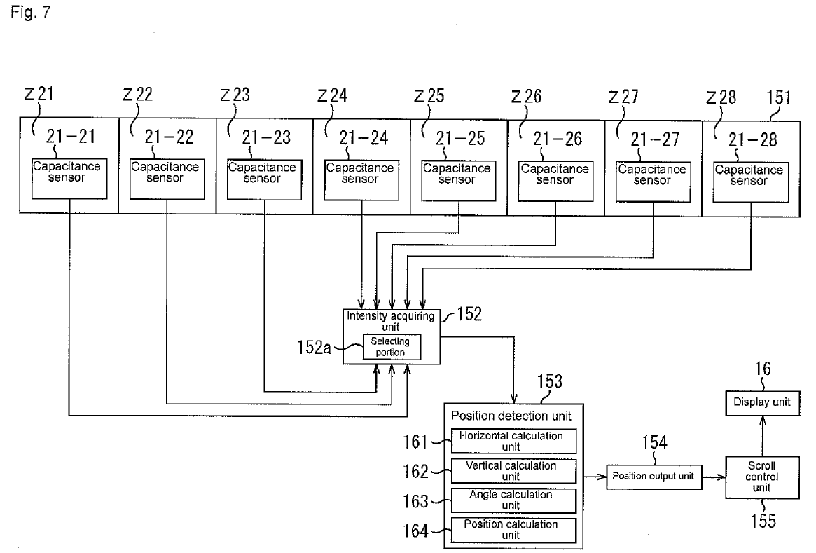

An example of scrolling the display screen of the display unit 16 in correspondence to the movement of the finger on a contact section 151 from eight capacitance sensors linearly arranged at equal interval will now be described with reference to FIG. 7. In the touch sensor of FIG. 7, configurations having the same functions as the touch sensor of FIG. 1 or 4 are denoted with the same reference numerals, and the description thereof will be appropriately omitted.

In the touch sensor of FIG. 7, the basic configuration of the contact section 151 is such that capacitance sensors 21-21 to 21-28 are linearly arranged at equal interval in place of the capacitance sensors 21-1 to 21-4 or 21-11 to 21-18 in the contact section 11 or 111, where the capacitance sensor 21-21 is arranged in a region Z21, the capacitance sensor 21-22 is arranged in a region Z22, the capacitance sensor 21-23 is arranged in a region Z23, the capacitance sensor 21-24 is arranged in a region Z24, the capacitance sensor 21-25 is arranged in a region Z25, the capacitance sensor 21-26 is arranged in a region Z26, the capacitance sensor 21-27 is arranged in a region Z27, and the capacitance sensor 21-28 is arranged in a region Z28. The contact section 151 is thus configured as a linear plate, where the finger of the user controls scrolling by touching and tracing the contact section 151 to the left and the right in the figure. The capacitance sensors 21-21 to 21-28, the capacitance sensors 21-1 to 21-4 and 21-11 to 21-18 are all similar.

The capacitance sensors 21-21 to 21-28 each detects the intensity of change in capacitance that occurs when an object is brought into contact or brought into proximity, and provides the detected intensity of the change in capacitance to an intensity acquiring unit 152 as detection result.

The intensity acquiring unit 152 basically has a configuration similar to the intensity acquiring unit 112, and controls a selecting portion 152a, and causes the selecting portion 152a to select the intensity of four capacitance sensors 21 arranged in succession including, of the eight detection results indicating the intensity of the change in capacitance provided by each of capacitance sensors 21-11 to 21-18, intensity of the capacitance sensor 21_max detecting the strongest intensity, intensity of two capacitance sensors 21_ne adjacent to the capacitance sensor 21_max, and intensity of the capacitance sensor 21_subne, which is not the capacitance sensor 21_max, adjacent to the capacitance sensor 21_ne of larger intensity of the two capacitance sensors 21_ne, and to provide them to a position detection unit 153 as detection results A to D.

The position detection unit 153 includes a horizontal calculation unit 161, a vertical calculation unit 162, an angle calculation unit 163, and an angle correction unit 164. The horizontal calculation unit 161, the vertical calculation unit 162, and the angle calculation unit 163 are of configurations having the same functions as the horizontal calculation unit 31, the vertical calculation unit 32, and the angle calculation unit 34, or the horizontal calculation unit 131, the vertical calculation unit 132, and the angle calculation unit 134. The position calculation unit 164 obtains a position on the contact section 151 according to an installation interval of the capacitance sensor 21 based on the angle θ calculated by the angle calculation unit 134.

The position output unit 154 provides the horizontal position x, the vertical position y, and the angle θ provided by the position detection unit 153 to the scroll control unit 155.

The scroll control unit 155 scrolls, in a horizontal direction and a vertical direction, an image displayed on the display unit 16 based on the horizontal position x, the vertical position y, and the angle θ provided from the position output unit 14 every second.

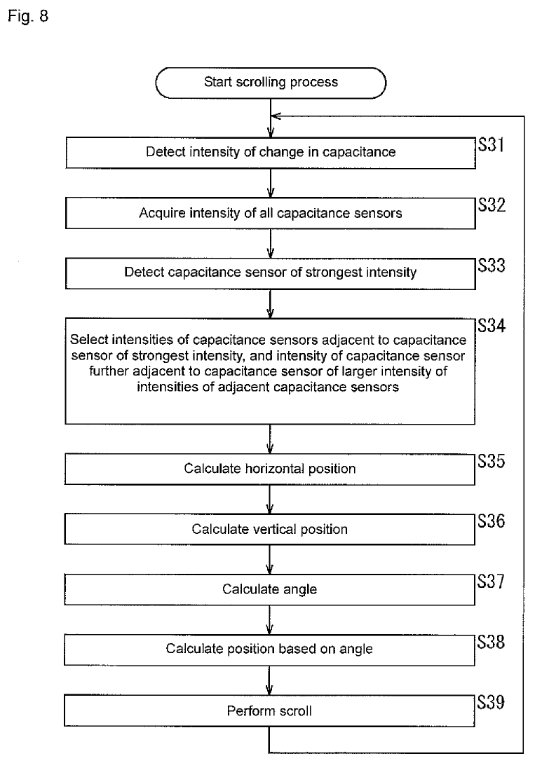

A scrolling process by the touch sensor of FIG. 7 will now be described with reference to a flowchart of FIG. 8.

In step S31, the capacitance sensors 21-21 to 21-28 of the contact section 151 respectively measure intensity of change in capacitance, and provide the intensity of change in capacitance, which is the measurement result, to the intensity acquiring unit 152.

In step S32, the intensity acquiring unit 152 acquires the respective intensity of change in capacitance provided from the capacitance sensors 21-21 to 21-28.

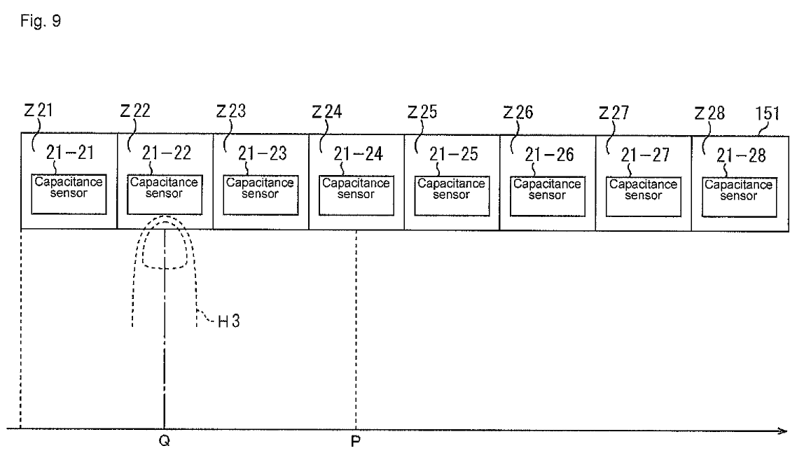

In step S33, the intensity acquiring unit 152 controls the selecting portion 152a to detect the detection result of the strongest intensity from the acquired intensities of change in capacitance of the capacitance sensors 21-21 to 21-28. In other words, for example, if a finger H3 exists on the region Z22 of the contact section 151, as shown in FIG. 9, the intensity of change in capacitance detected in the capacitance sensor 21-22 is detected as the strongest intensity. Thus, in the case shown in FIG. 9, the selecting portion 152a detects the detection result of the capacitance sensor 21-22 (capacitance sensor 21_max) in which the intensity of change in capacitance is detected as the strongest intensity.

In step S34, the selecting portion 152a selects the intensities of the two capacitance sensors 21_ne adjacent to the capacitance sensor 21_max of strongest intensity, and the intensity of the capacitance sensor 21_subne, which is not the capacitance sensor 21_max, adjacent to the capacitance sensor 21_ne detecting the larger intensity of the capacitance sensors 21_ne, and provides, with the intensity of the capacitance sensor 21_max, to the position detection unit 153 as detection results A to D corresponding to the first quadrant to the fourth quadrant in counterclockwise in the order of four successive regions.

In other words, in the case of FIG. 9, the intensity, which is the detection result of the capacitance sensor 21-22, is the strongest, and thus the selecting portion 152a selects the intensity of the capacitance sensor 21-22 as the intensity of the capacitance sensor 21_max. The selecting portion 152a also selects the intensities of the capacitance sensors 21-21, 21-23 adjacent to the capacitance sensor 21-22 respectively as the intensity of capacitance sensor 21_ne. Furthermore, if the intensity of the capacitance sensor 21-23 is stronger of the detection results of the capacitance sensors 21-21, 21-23, for example, the selecting portion 152a selects the intensity of the capacitance sensor 21-24, which is not the capacitance sensor 21-22 (capacitance sensor 21_max), adjacent to the capacitance sensor 21-23 as the intensity of the capacitance sensor 21_subne.

As a result, the selecting portion 152a selects the detection results detected in each of capacitance sensors 21-21 to 21-24 as detection results A to D, and provides the same to the position detection unit 153

That is, the detection results of the capacitance sensors 21-21 to 21-24 of the regions Z21 to Z24 shown in FIG. 9 are handled similar to the detection results of the capacitance sensors 21-1 to 21-4 of the regions Z1 to Z4 in the first quadrant to the fourth quadrant in FIG. 3, and are provided to the position detection unit 153.

In step S35, the horizontal calculation unit 161 obtains the horizontal position x by calculating equation (1).

In other words, the horizontal calculation unit 161 handles the sum of the detection results of the capacitance sensors 21-21, 21-24 of FIG. 9 as if the sum of the detection results of the first quadrant and the fourth quadrant in FIG. 3, and handles the sum of the detection results of the capacitance sensors 21-22, 21-23 of FIG. 9 as if the sum of the detection results of the second quadrant and the third quadrant in FIG. 3, and calculates equation (1) of subtracting the respective sum to obtain, as the horizontal position x, the bias in intensity of change in the capacitance in the horizontal direction by the finger H3 brought into contact or brought into proximity with the contact section 151 (difference in change in left and right capacitances of the contact section 151 in the figure) as being the bias in intensity of change in the capacitance in the horizontal direction by the finger H1 brought into contact or brought into proximity with the contact section 11 (difference in change in left and right capacitances of the contact section 11 in the figure).

The finger H1 in FIG. 3 is handled as existing on the region Z2 when corresponding to the finger H3 shown in FIG. 9. As hereinafter described, the horizontal position x is the horizontal position corresponding to FIG. 3, and differs from the horizontal position shown in FIG. 9.

In step S36, the vertical calculation unit 162 obtains the vertical position y by calculating equation (2).

In other words, the vertical calculation unit 162 handles the sum of the detection results of the capacitance sensors 21-21, 21-22 of FIG. 9 as if the sum of the detection results of the first quadrant and the second quadrant in FIG. 3, and handles the sum of the detection results of the capacitance sensors 21-23, 21-24 of FIG. 9 as if the sum of the detection results of the third quadrant and the fourth quadrant in FIG. 3, and calculates equation (2) of subtracting the respective sum to obtain, as the vertical position y, the bias in intensity of change in the capacitance in the vertical direction by the finger H3 brought into contact or brought into proximity with the contact section 151 (difference in change in up and down capacitances of the contact section 151 in the figure) as being the bias in intensity of change in the capacitance in the horizontal direction by the finger H1 brought into contact or brought into proximity with the contact section 11 (difference in change in up and down capacitances of the contact section 11 in the figure).

As hereinafter described, the vertical position y is the vertical position corresponding to FIG. 3, and differs from the vertical position shown in FIG. 9.

In step S37, the distance calculation unit 163 obtains the angle θ by calculating the equation (4).

In other words, the angle calculation unit 163 calculates equation (4) to obtain the angle θ corresponding to the value of (y/x) with reference to the angle table 153a from the horizontal position x and the vertical position y of the position of the finger H1 of FIG. 3 corresponding to the finger H3 brought into contact or brought into proximity with the contact section 151 of FIG. 9.

As hereinafter described, the angle θ corresponds to FIG. 3.

In step S38, the position calculation unit 164 calculates the angle θ in FIG. 3 as the horizontal position in FIG. 9. In other words, since the detection results of the capacitance sensors 21-21 to 21-24 are handled as detection results of the first quadrant to the fourth quadrant in FIG. 3, the range of the angle θ obtained in the process of step S27 is 0°≦θ<360°. However, in FIG. 9, the capacitance sensors 21-21 to 21-24 are arranged in regions Z21 to Z24. For instance, assuming the horizontal length is length P, the angle θ can be assumed as a value representing the position Q which range is 0≦Q≦P in the range of 0°≦θ<360°. The position calculation unit 164 calculates the position Q where the finger H3 is brought into contact or brought into proximity by the angle θ through the calculation expressed in equation (6) below.

Q=(P/360)×θ (6)

In equation (6), P represents the length at where a region in which four successively arranged capacitance sensors 21 detecting the intensity selected by the selecting portion 152a measure the intensity of change in capacitance exists. In the case of FIG. 9, the region in which four successively arranged capacitance sensors 21 detecting the selected intensity measure the intensity of change in capacitance is the length P of the regions Z21 to Z24. Therefore, the position calculation unit 164 multiplies P/360 to the angle θ to calculate the position Q shown in FIG. 9 from the angle θ shown in FIG. 3.

In step S39, the position detection unit 153 outputs, to the position output unit 154, the position x calculated by the horizontal calculation unit 161, the position y calculated by the vertical calculation unit 162, and the position Q calculated by the position calculation unit 164. The position output unit 154 provides the positions x, y and the position Q provided from the position detection unit 153 to the scroll control unit 155. The scroll control unit 155 obtains a difference between a position Qp immediately before and a provided current position Qc, and scrolls the display content of the display unit 16 according to the magnitude thereof, and the process returns to step S31.

Through the above processes, even with the touch sensor including capacitance sensors linearly arranged at equal interval, processing similar to the touch sensor including four capacitance sensors concentrically arranged at equal interval can be performed by using the detection results of the four successively arranged capacitance sensors including the capacitance sensor indicating the detection result of strongest intensity at the end or at a position other than the capacitance sensor adjacent to the capacitance sensor at the end, and the contact position or the proximate position on the contact section 151 can be accurately obtained with successive values. As a result, the scrolling amount of the screen can be accurately controlled based on the position of the finger H3 that is accurately obtained.

If the capacitance sensor indicating the detection result of strongest intensity is the capacitance sensor at the end or the capacitance sensor adjacent to the capacitance sensor at the end, similar effects can be obtained by performing the processing similar to the touch sensor including four capacitance sensors concentrically arranged at equal interval through the used of the detection results of the four capacitance sensors successively arranged from the end including the capacitance sensor indicating the detection result of the strongest intensity. In other words, if the capacitance sensor indicating the detection result of the strongest intensity is included, the contact position or the proximate position on the contact section can be obtained from the four successively arranged capacitance sensors.

It should be recognized that processing is performed such that the capacitance sensor indicating the detection result of the strongest intensity is not selected for the end of the four successively arranged capacitance sensors because the detection results of the top four capacitance sensors close to the contact position or the proximate position can be used if the capacitance sensor indicating the detection result of the strongest intensity is not at the end, whereby the contact position or the proximate position can be obtained at high accuracy. Therefore, if the capacitance sensor indicating the detection result of the strongest intensity is the capacitance sensor at the end or the capacitance sensor adjacent to the capacitance sensor at the end, the detection results of the four capacitance sensors successively arranged from the end including the capacitance sensor indicating the detection result of the strongest intensity is used so that, although the accuracy slightly degrades, the detection results of the top four capacitance sensors can be used, and the contact position or the proximate position can be detected at high precision.

The contact position or the proximate position obtained through the above method is obtained only from the relative relationship among each capacitance sensor, and is not influenced by the magnitude of the total change in amount of the capacitance. That is, influence of the fluctuation of the area of the finger that is brought into contact or brought into proximity is less likely to be subjected to, the output in time of contact or proximity is stabilized, and an accurate position of the finger can be detected.

Furthermore, in the above description, response can be made with the same calculation formula even in the case of various touch sensors such as a wheel sensor in which the capacitance sensors are annularly arranged, and a slide sensor in which the capacitance sensors are linearly arranged.

In the case of the wheel sensor, the output of the position where the finger is brought into contact or brought into proximity may be outputted as a coordinate, and thus error determination may be made according to the contact position or the proximate position, or the coordinate of the contact position or the proximate position necessary on the touch panel and the like may be directly outputted.

Even in simultaneous pushing due to rapid temperature change and voltage fluctuation, or attachment of water etc., the positions x, y obtained by equation (1) are not influenced since the capacity fluctuation of the same magnitude occur in the four capacitance sensors. Thus, an accurate position can be detected without being influenced by change in environment.

When the intensity of change in capacitance is not the same but fluctuates in the same direction, the angle θ obtained from the horizontal position x and the vertical position y is used, and thus the influence thereof can be suppressed. Therefore, the angle θ obtained using the values of the positions x, y is less susceptible to the variation in sensitivity among the capacitance sensors and the consistent fluctuation in the intensity of change in capacitance, and thus the contact position or the proximate position can be accurately detected without being influenced by the change in environment.

If the capacitance sensors are annularly arranged, the distance r obtained as the calculation result can be used as a judgment standard of contact (or proximity) or non-contact (or non-proximity) with respect to the contact section, and thus if a plurality of capacitance sensors is simultaneously influenced by the same extent, judgment may not be made as contacting or being proximate, and as a result, the contact position or the proximate position can be accurately obtained.

When brought into contact or into proximity to the center of the contact section, if the contact position or the proximate position is shifted from the center, offset may be added to the measurement values of the positions x, y for correction so that the detected center coincides with the actual center, where the contact position or the proximate position can be more accurately detected by such correction.

When the sensitivity varies among the capacitance sensors, if twice or more difference is found between the capacitance sensors, in order to reduce the sensitivity difference, the amount of change in capacitances are divided from each other when in contact or in proximity (actually, subtraction is performed to check how many subtractions are carried out to become smaller than or equal to zero) and the quotient is multiplied to the smaller one to thereby perform a correction such that the sensitivity difference becomes smaller than or equal to double.

If the calculation results of the positions x, y are the middle of predetermined numerical values, the calculation results of the positions x, y may switch between the numerical values at high speed. In this case, the calculation results of the positions x, y are prevented from being switched at high speed by holding either value for a constant time, and performing a process of switching to the other value only when the other value is calculated without change.

As described above, according to one or more embodiments of the present invention, the position where the object is brought into contact or brought into proximity of the contacting region arranged with the capacitance sensors can be detected at high accuracy by successive values with a small number of capacitance sensors.

The series of text processes can be executed not only by hardware, but also by software. When executing the series of processes by software, the program configuring the software is installed from a recording medium to a computer incorporated in a dedicated hardware or a general-purpose personal computer and the like capable of executing various functions by installing various programs.

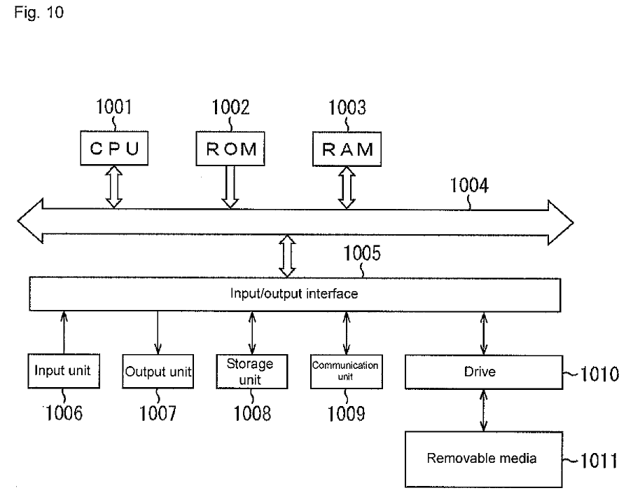

FIG. 10 shows a configuration example of a general-purpose personal computer. The personal computer incorporates a CPU (Central Processing Unit) 1001. The CPU 1001 is connected with an input/output interface 1005 through a bus 1004. The bus 1004 is connected with a ROM (Read Only Memory) 1002 and a RAM (Random Access Memory) 1003.

The input/output interface 1005 is connected with an input unit 1006 including an input device such as a keyboard and a mouse for the user to input an operation command, an output unit 1007 for outputting a processing operation screen and an image of the processing result to a display device, a storage unit 1008 including a hard disc drive and the like for storing programs and various data, and a communication unit 1009 including a LAN (Local Area Network) adapter and the like for executing a communication process through a network represented by Internet. A drive 1010 is also connected for reading and writing data with respect to a removable media 1011 such as a magnetic disk (include a flexible disk), an optical disk (include a CD-ROM (Compact Disc-Read Only Memory), a DVD (Digital Versatile Disc)), a magnetic optical disk (include an MD (Mini Disc), or a semiconductor memory.

The CPU 1001 executes various processes according to a program stored in the ROM 1002, or a program read out from the removable media 1011 such as the magnetic disk, the optical disk, the magnetic optical disk, or the semiconductor memory, installed in the storage unit 1008, and loaded from the storage unit 1008 to the RAM 1003. The RAM 1003 also appropriately stores data etc. necessary for the CPU 1001 to execute various processes.

In the present specification, the steps describing the program recorded in a recording medium includes not only processes performed in time-series in the described order, but also processes executed in parallel or individually even if not necessarily processed in time-series.

1. A touch sensor comprising:
a plurality of detection parts including a sensor for detecting change in capacitance when an object is brought into contact or brought into proximity to at least four or more successively divided contact regions;
an acquiring part for acquiring a first detection result of the detection part detecting a value at which the change in capacitance detected by the detection part is the largest, second and third detection results of the detection parts adjacent to the detection part detecting the first detection result, and a fourth detection result of the detection part, which is not the detection part detecting the first detection result, adjacent to the detection part of either one out of the second and the third detection results, as detection results of a first quadrant to a fourth quadrant when annularly arranged with respect to the first quadrant to the fourth quadrant in correspondence to the arrangement of the detection parts;
a horizontal position calculation part for calculating a detection position in a horizontal direction of a position the object is brought into contact or brought into proximity with a center position of the detection parts arranged in the first quadrant to the fourth quadrant as a reference by subtracting a sum of the detection result of the second quadrant and the detection result of the third quadrant from a sum of the detection result of the first quadrant and the detection result of the fourth quadrant,
a vertical position calculation part for calculating a detection position in a vertical direction of a position the object is brought into contact or brought into proximity with a center position of the detection parts arranged in the first quadrant to the fourth quadrant as a reference by subtracting a sum of the detection result of the third quadrant and the detection result of the fourth quadrant from a sum of the detection result of the first quadrant and the detection result of the second quadrant; and
an output part for outputting the positions in the horizontal direction and the vertical direction of the position the object is brought into contact or brought into proximity calculated by the horizontal calculation part and the vertical calculation part.

2. The touch sensor according to claim 1, wherein the acquiring part acquires the first detection result of the detection part detecting a value at which the change in capacitance detected by the detection part is the largest, the second and third detection results of the detection parts adjacent to the detection part detecting the first detection result, and the fourth detection result of the detection part, which is not the detection part detecting the first detection result, adjacent to the detection part of larger detection result of the second and the third detection results, as detection results of a first quadrant to a fourth quadrant when annularly arranged with respect to the first quadrant to the fourth quadrant in correspondence to the arrangement of the detection parts.

3. The touch sensor according to claim 1, further comprising an angle calculation part for calculating an angle with respect to the horizontal direction or the vertical direction of the position the object is brought into contact or brought into proximity with the center position of the detection parts arranged in the first quadrant to the fourth quadrant as a reference from the positions in the horizontal direction and the vertical direction of the position the object is brought into contact or brought into proximity calculated by the horizontal calculation part and the vertical calculation part.

4. The touch sensor according to claim 1, further comprising a distance calculation part for calculating a distance from the center position of the detection parts arranged in the first quadrant to the fourth quadrant to the position the object is brought into contact or brought into proximity from the positions in the horizontal direction and the vertical direction of the position the object is brought into contact or brought into proximity calculated by the horizontal calculation part and the vertical calculation part.

5. The touch sensor according to claim 3, further comprising a scroll part for scrolling an image in correspondence to change in positions in the horizontal direction and the vertical direction of the position the object is brought into contact or brought into proximity outputted by the output part; wherein
the scroll part changes scroll speed based on the distance and the angle.

6. The touch sensor according to claim 1, wherein assumption is made as error in a case where the distance from the center position of the detection parts arranged in the first quadrant to the fourth quadrant to the position the object is brought into contact or brought into proximity calculated by the distance calculation part is not a magnitude of a predetermined range; and
the output part stops the output of the positions in the horizontal direction and the vertical direction of the position the object is brought into contact or brought into proximity.

7. The touch sensor according to claim 1, wherein the plurality of detection parts are linearly arranged.

8. The touch sensor according to claim 7, wherein if the detection part detecting the first detection result is arranged at an end of the linear arrangement or adjacent to the detection part at the end, the acquiring part acquires the detection results of four detection parts in succession from the end including the first detection result as the detection results of the first quadrant to the fourth quadrant when annularly arranged with respect to the first quadrant to the fourth quadrant in correspondence to the arrangement of the detection parts.

9. The touch sensor according to claim 1, wherein the plurality of detection parts are annularly arranged.

10. A method for controlling a touch sensor including a plurality of detection parts including a sensor for detecting change in capacitance when an object is brought into contact or brought into proximity to at least four or more successively divided contact regions; the method comprising:
an acquiring step of acquiring a first detection result of the detection part detecting a value at which the change in capacitance detected by the detection part is the largest, second and third detection results of the detection parts adjacent to the detection part detecting the first detection result, and a fourth detection result of the detection part, which is not the detection part detecting the first detection result, adjacent to the detection part of either one out of the second and the third detection results, as detection results of a first quadrant to a fourth quadrant when annularly arranged with respect to the first quadrant to the fourth quadrant in correspondence to the arrangement of the detection parts;
a horizontal position calculation step of calculating a detection position in a horizontal direction of a position the object is brought into contact or brought into proximity with a center position of the detection parts arranged in the first quadrant to the fourth quadrant as a reference by subtracting a sum of the detection result of the second quadrant and the detection result of the third quadrant from a sum of the detection result of the first quadrant and the detection result of the fourth quadrant,
a vertical position calculation step of calculating a detection position in a vertical direction of a position the object is brought into contact or brought into proximity with a center position of the detection parts arranged in the first quadrant to the fourth quadrant as a reference by subtracting a sum of the detection result of the third quadrant and the detection result of the fourth quadrant from a sum of the detection result of the first quadrant and the detection result of the second quadrant; and
an output step of outputting the positions in the horizontal direction and the vertical direction of the position the object is brought into contact or brought into proximity calculated by the process of the horizontal calculation step and the process of the vertical calculation step.

11. A computer readable medium storing a program for controlling a touch sensor, which includes a plurality of detection parts including a sensor for detecting change in capacitance when an object is brought into contact or brought into proximity to at least four or more successively divided contact regions, the program comprising functionality to cause a computer to perform:
an acquiring step of acquiring a first detection result of the detection part detecting a value at which the change in capacitance detected by the detection part is the largest, second and third detection results of the detection parts adjacent to the detection part detecting the first detection result, and a fourth detection result of the detection part, which is not the detection part detecting the first detection result, adjacent to the detection part of either one out of the second and the third detection results, as detection results of a first quadrant to a fourth quadrant when annularly arranged with respect to the first quadrant to the fourth quadrant in correspondence to the arrangement of the detection parts;
a horizontal position calculation step of calculating a detection position in a horizontal direction of a position the object is brought into contact or brought into proximity with a center position of the detection parts arranged in the first quadrant to the fourth quadrant as a reference by subtracting a sum of the detection result of the second quadrant and the detection result of the third quadrant from a sum of the detection result of the first quadrant and the detection result of the fourth quadrant,
a vertical position calculation step of calculating a detection position in a vertical direction of a position the object is brought into contact or brought into proximity with a center position of the detection parts arranged in the first quadrant to the fourth quadrant as a reference by subtracting a sum of the detection result of the third quadrant and the detection result of the fourth quadrant from a sum of the detection result of the first quadrant and the detection result of the second quadrant; and
an output step of outputting the positions in the horizontal direction and the vertical direction of the position the object is brought into contact or brought into proximity calculated by the process of the horizontal calculation step and the process of the vertical calculation step.

12. The touch sensor according to claim 4, further comprising a scroll part for scrolling an image in correspondence to change in positions in the horizontal direction and the vertical direction of the position the object is brought into contact or brought into proximity outputted by the output part; wherein
the scroll part changes scroll speed based on the distance and the angle.
